(19) United States
(12) Patent Application Publication
(10) Pub. No.: US 2016/0191478 A1
(43) Pub. Date: Jun. 30, 2016

(54) METHOD AND COMPUTING DEVICE FOR INTEGRATING A KEY MANAGEMENT SYSTEM WITH PRE-SHARED KEY (PSK)-AUTHENTICATED INTERNET KEY EXCHANGE (IKE)

(71) Applicant: MOTOROLA SOLUTIONS, INC, SCHAUMBURG, IL (US)

(72) Inventors: BRIAN W. PRUSS, STREAMWOOD, IL (US); MARK A. BOERGER, PLANTATION, FL (US); ROBERT HORVATH, ARLINGTON HEIGHTS, IL (US); ADDAM L. KRUCEK, CRYSTAL LAKE, IL (US)

(21) Appl. No.: 14/587,055

(22) Filed: Dec. 31, 2014

(51) Int. Cl. H04L 29/06

(52) U.S. Cl. CPC H04L 63/061; H04L 63/0428

(57) ABSTRACT

A method and computing device for integrating a key management system with a Pre-Shared Key (PSK)-authenticated Internet Key Exchange (IKE). The method comprises the following: An IKE Identification Payload including an Identification Data field is generated via a first computing device. The Identification Data field comprises: a user identifier (ID) field uniquely identifying one or more of a user of the first computing device and the first computing device; a key ID field uniquely identifying a PSK; and a separator between the user ID field and the key ID field. The IKE Identification Payload is transmitted from the first computing device to a second computing device as part of the IKE.

### BACKGROUND OF THE INVENTION

In digital radio communications, some applications require an encrypted internet protocol (IP) link suitable for large numbers of users using Internet Key Exchange (IKE), as defined, for example, in Request For Comments (RFC) 2409, RFC 4306 or RFC 5996, for Security Association (SA) establishment. These applications include voice and data communications over a Long-Term Evolution (LTE) transport, such as Motorola APX™.

Motorola APX™ uses the Association of Public-safety Communications Officers Project 25 (APCO P25) Over-The-Air Rekeying (OTAR) standard for management of keys for voice communications. The APCO P25 standard is a digital public safety radio communications standard for first-responders and homeland security/emergency response professionals. Motorola Solutions, Inc. APX™-series radios use a Pre-Shared Key (PSK) for IKE authentication, which needs to be replaced periodically to maintain security.

Devices on a APCO P25 network have a need to establish Virtual Private Network (VPN) connections using standard protocols to negotiate session parameters. These protocols require an authentication mechanism to prove that supplicants requesting connections are allowed. Not all APCO P25 devices have the capacity to use public-key-based authentication mechanisms, and therefore Pre-Shared Key (PSK) based authentication serves as an alternative.

However, such alternative authentication requires that PSKs be initially distributed to the devices, and best-practice security rules dictate that the PSKs must be periodically refreshed. APCO P25 provides a proven and trusted mechanism to distribute and update keys, but does not directly integrate with IKE. Therefore, a mechanism is required to identify the key in use and tie it to a APCO P25 key identity.

While IKE provides an Identity field that can be used to identify and select keys, common IKE implementations only allow one connection using a single ID value.

There is currently no convention for tying APCO P25 key management to IKE ID values, while allowing multiple connections using the same key. Also, APCO P25 key management is not used for management of IKE authentication PSKs.

Accordingly, there is a need for a method and computing device for integrating a key management system with a PSK-authenticated IKE.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an IKE Identification Payload in accordance with some embodiments.

FIG. 2 is another block diagram of an IKE Identification Payload in accordance with some embodiments.

FIG. 3 is a block diagram of a system for integrating a key management system with a PSK-authenticated IKE in accordance with some embodiments.

FIG. 4 is a flow diagram of a method of integrating a key management system with a PSK-authenticated IKE in accordance with some embodiments.

FIG. 5 is a flow diagram of a method of integrating a key management system with a PSK-authenticated IKE in accordance with some embodiments.

FIG. 6 is a schematic of a second computing device in accordance with some embodiments.

FIG. 7 is a schematic of a first computing device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

According to certain embodiments, the present invention resides in a method of integrating a key management system with a Pre-Shared Key (PSK)-authenticated Internet Key Exchange (IKE). The method comprises the following: An IKE Identification Payload including an Identification Data field is generated via a first computing device. The Identification Data field comprises: a user identifier (ID) field uniquely identifying one or more of a user of the first computing device and the first computing device; a key ID field uniquely identifying a PSK; and a separator between the user ID field and the key ID field. The IKE Identification Payload is then transmitted from the first computing device to a second computing device as part of the IKE.

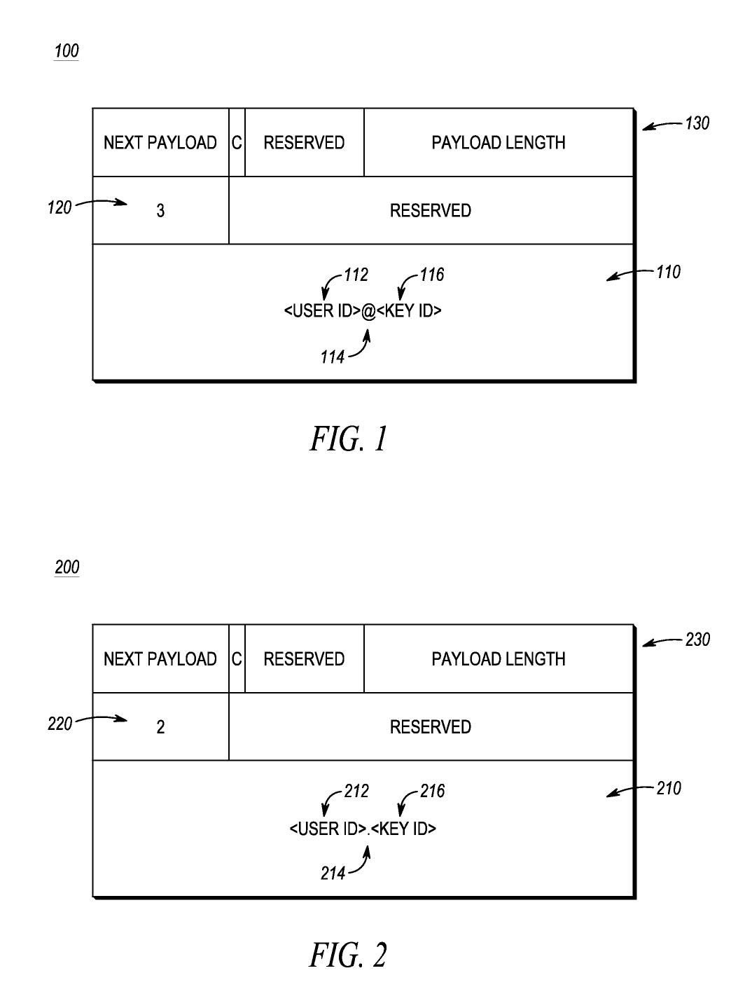

FIG. 1 is a block diagram of an IKE Identification Payload 100 in accordance with some embodiments. The IKE Identification Payload 100 includes an Identification Data field 110, an ID Type field 120 and an IKE Payload header 130.

The Identification Data field 110 comprises a user ID field 112, a key ID field 116 and a separator 114 in the form of an “@” character between the user ID field 112 and the key ID field 116.

The user ID field 112 identifies a user, a computing device or a connection. In some embodiments, the user ID field 112 comprises one or more of the following: a device serial number of the first computing device; a subscriber ID of the first computing device; and a subscriber ID of the user. If the user ID field 112 comprises multiple identifiers, another separator that is different from the separator 114 can be used between the identifiers. For example, the user ID field 112 can have the format “<device serial number>-<subscriber ID>”.

The key ID field 116 identifies a PSK, for example, an active PSK for the user, computing device or connection. In some embodiments, the key ID field 116 comprises a key ID and one or more of the following: a communications standard ID; a manufacturer ID; and an algorithm ID. If the key ID field 116 comprises multiple identifiers, one or more other separators that are different from the separator 114 can be used between the identifiers. For example, the key ID field 116 can have the format: “<communications standard ID>.<manufacturer ID>.<algorithm ID>-<key ID>”.

The ID Type field 120 comprises a value of “3”, which specifies that the data in the Identification Data field 110 is formatted as a fully-qualified Request For Comments (RFC) 822 email address string (RFC822_ADDR). The user ID field 112 is shown in a user portion of the RFC822_ADDR and the key ID field 116 is shown in a domain portion of the RFC822_ADDR. However, in some embodiments, the position of the user ID field 112 and the key ID field 116 are reversed such that the user ID field 112 is in the domain portion of the RFC822_ADDR and the key ID field 116 is in the user portion of the RFC822_ADDR.

FIG. 2 is a block diagram of an IKE Identification Payload 200 in accordance with some embodiments. The IKE Identification Payload 200 includes an Identification Data field 210, an ID Type field 220 and an IKE Payload header 230.

The Identification Data field 210 comprises a user ID field 212, a key ID field 216 and a separator 214 in the form of an “.” character between the user ID field 212 and the key ID field 216.

The ID Type field 220 comprises a value of “2”, which specifies that the data in the Identification Data field 210 is formatted as a fully-qualified domain name string (FQDN). The user ID field 212 is shown as a second-level domain (SLD) in the FQDN and the key ID field 216 is shown as a top-level domain (TLD) in the FQDN. However, in some embodiments, the position of the user ID field 212 and the key ID field 216 are reversed such that the user ID field 212 is the TLD in the FQDN and the key ID field 216 is the SLD in the FQDN.

IKE Identification Payloads enable computing devices to assert an identity to one another as part of an IKE. The IKE Identification Payload 100 and the IKE Identification Payload 200 shown in FIGS. 1 and 2, respectively, conform to IKE version two (IKEv2) as defined, for example, in RFC 4306 and RFC 5996. However, an FQDN or RFC822_ADDR in an Identification Data field of an IKE Identification Payload conforming to IKE version one (IKEv1) can also be formatted to have a user ID field, a key ID field and a separator between the user ID field and the key ID field, as described above.

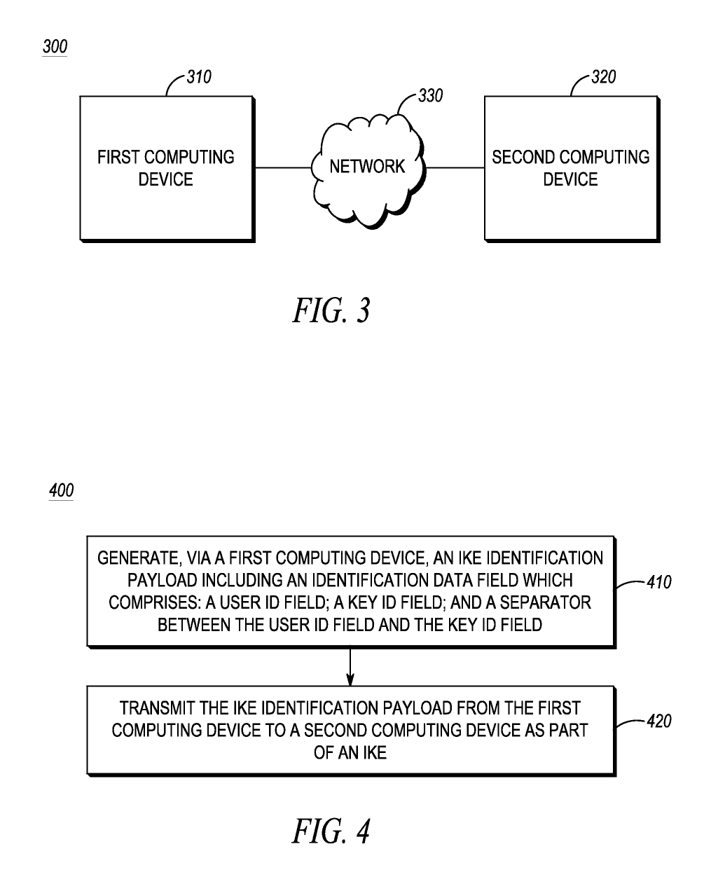

FIG. 3 is a block diagram of a system 300 for integrating a key management system with a PSK-authenticated IKE in accordance with some embodiments. The system 300 comprises a first computing device 310 in communication with a second computing device 320 via a communications network 330. The key management system can be, for example, an APCO Project 25 (P25) key management system. The first computing device 310 is, for example, an IKE client or initiator and the second computing device 320 is, for example, an IKE server or responder. The communications network 330 is, for example an APCO P25 network running over an LTE transport.

The first computing device 310 generates an IKE Identification Payload, such as IKE Identification Payloads 100 and 200, to transmit to the second computing device 320 via the communications network 330. The IKE Identification Payload includes an Identification Data field, such as Identification Data fields 110 and 210, which comprises: a user ID field; a key ID field; and a separator between the user ID field and the key ID field.

The second computing device 320 receives the IKE Identification Payload from the first computing device 310. The second computing device 320 uses the user ID field to identify one or more of a user of the first computing device 310, the first computing device 310, and a connection between the first computing device 310 and another computing device. The second computing device 320 identifies a unique PSK corresponding to the key ID field.

The first computing device 310 can therefore identify to the second computing device 320 an active key for one or more of a user of the first computing device 310, the first computing device 310 and/or a connection between the first computing device 310 and another computing device. The system 300 enables different users, computing devices and/or connections to use different keys depending on whether or not an Over-The-Air Rekeying (OTAR) instruction to switch keys within the key management system has been received at the first computing device 310.

FIG. 4 is a flow diagram of a method 400 of integrating a key management system with a PSK-authenticated IKE in accordance with some embodiments. For example, the method 400 is performed at the first computing device 310. The method comprises the following steps:

At step 410, an IKE Identification Payload, such as IKE Identification Payloads 100 and 200, including an Identification Data field, such as Identification Data fields 110 and 210, is generated via a first computing device. The Identification Data field comprises: a user ID field uniquely identifying one or more of a user of the first computing device and the first computing device; a key ID field uniquely identifying a PSK; and a separator between the user ID field and the key ID field.

At step 420, the IKE Identification Payload is transmitted from the first computing device to a second computing device as part of the IKE.

The key ID field in the Identification Data field of the IKE Identification Payload enables the second computing device to identify the PSK. The user ID field in the Identification Data field of the IKE Identification Payload enables the second computing device to identify one or more of the user, the first computing device, and a connection between the first computing device and another computing device.

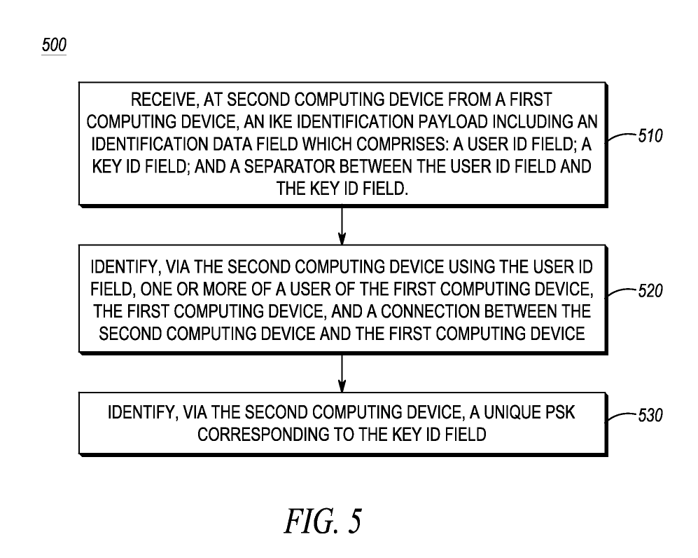

FIG. 5 is a flow diagram of a method 500 of integrating a key management system with a PSK-authenticated IKE in accordance with some embodiments. For example, the method 500 is performed at the second computing device 320, for example, in conjunction with the method 400 performed at the first computing device 310. The method comprises the following steps:

At step 510, an IKE Identification Payload, such as IKE Identification Payloads 100 and 200, is received at a second computing device from a first computing device. The IKE Identification Payload includes an Identification Data field, such as Identification Data fields 110 and 210, comprising: a user ID field; a key ID field; and a separator between the user ID field and the key ID field.

At step 520, the second computing device uses the user ID field to identify one or more of a user of the first computing device, the first computing device, and a connection between the first computing device and another computing device.

At step 530, the second computing device identifies a unique PSK corresponding to the key ID field.

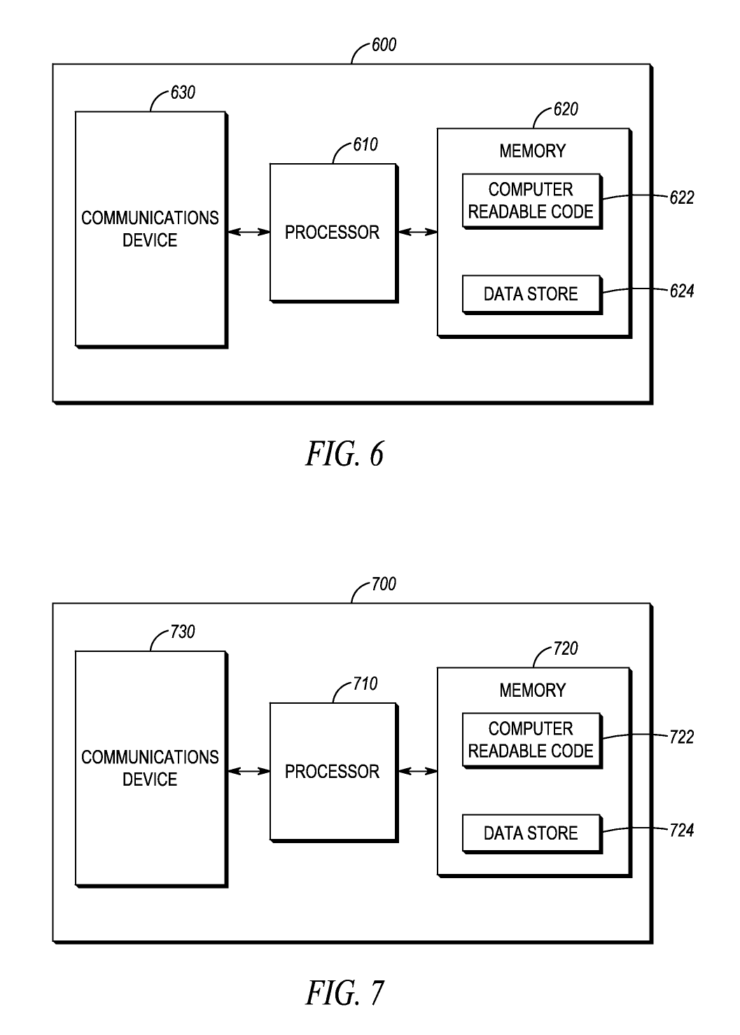

FIG. 6 is a schematic of a second computing device 600 in accordance with some embodiments. The second computing device 600 is, for example, identical to the second computing device 320. In some embodiments, the second computing device 600 is an IKE server.

The second computing device 600 comprises a processor 610. A memory 620 and one or more communications devices 630 are coupled to the processor 610. The memory 620 comprises computer instruction code 622 which is executable by the processor to perform various aspects of the present invention including various methods and functions of the embodiments described herein. In some embodiments, the memory 620 comprises computer instruction code 622 for performing one or more of the steps of the method 500.

The memory 620 can also include a data store 624 to store data such as the data used in the embodiments. As will be understood by a person skilled in the art, a single memory, such as the memory 620, can be used to store both dynamic and static data. The structure of the memory 620 is well known to those skilled in the art and can include a basic input/output system (BIOS) stored in a read only memory (ROM) and one or more program modules such as operating systems, application programs and program data stored in random access memory (RAM).

The one or more communications devices 630 can include, for example, an antenna to transmit and/or receive a radio communication, a network card or modem to transmit and/or receive a wired or wireless communication, and/or one or more other communications devices.

In some embodiments, the memory 620 comprises computer instruction code 622 executable by the processor 610 to perform the following: receiving, from a first computing device via the communications device, an IKE Identification Payload including an Identification Data field comprising: a user identifier (ID) field; a key identifier (ID) field; and a separator between the user ID field and the key ID field; identifying, using the user ID field, one or more of a user of the first computing device, the first computing device, and a connection between the first computing device and another computing device; and identifying a unique PSK corresponding to the key ID field.

In some embodiments, the computer instruction code 622 executable by the processor 610 identifies a unique PSK using a list of key IDs mapped to corresponding unique PSKs. The list of key IDs and the mapping to the PSKs can be stored in the data store 624, for example, in an “ipsec.secrets” file which indicates which key to use for each connection. In some embodiments, an “ipsec.secrets” file entry has the format: “<User ID>@<Key ID>:PSK <PSK>”.

In some embodiments, the memory 620 comprises computer instruction code 622 executable by the processor 610 to map a user ID, for example, identifying one or more of the user of the first computing device or the first computing device, to an invalid PSK.

In some embodiments, the memory 620 comprises computer instruction code 622 executable by the processor 610 to map a user ID, for example, identifying one or more of the user of the first computing device or the first computing device, to a valid PSK.

In these embodiments, the user IDs that are not mapped to an invalid PSK or a valid PSK can be mapped to an invalid or valid PSK using a wildcard, such as “*”. For example, an “ipsec.secrets” file entry could be: ‘*@“Unique Key ID”:PSK “v+Nk×Y9LLZvwj4qCC2o/gGrWD2d21jL”’.

Mapping user IDs to valid or invalid PSKs enables user IDs, for example, identifying one or more of a user of a computing device or a computing device, to be blacklisted or whitelisted. In one example, a user ID identifying the first computing device is mapped to an invalid PSK and the invalid PSK is used to fail authentication of the first computing device. In another example, a user ID identifying the first computing device is mapped to a valid PSK and the valid PSK is used to successfully authenticate the first computing device.

FIG. 7 is a schematic of a first computing device 700 in accordance with some embodiments. The first computing device 700 is, for example, identical to the first computing device 310. In some embodiments, the first computing device 700 is an IKE client within a P25 device.

The first computing device 700 comprises a processor 710. A memory 720 and one or more communications devices 730 are coupled to the processor 710. The memory 720 comprises computer instruction code 722 which is executable by the processor to perform various aspects of the present invention including various methods and functions of the embodiments described herein. In some embodiments, the memory 720 comprises computer instruction code 722 for performing one or more of the steps of the method 400.

The memory 720 can also include a data store 724 to store data such as the data used in the embodiments. As will be understood by a person skilled in the art, a single memory, such as the memory 720, can be used to store both dynamic and static data. The structure of the memory 720 is well known to those skilled in the art and can include a basic input/output system (BIOS) stored in a read only memory (ROM) and one or more program modules such as operating systems, application programs and program data stored in random access memory (RAM).

The one or more communications devices 730 can include, for example, an antenna to transmit and/or receive a radio communication, a network card or modem to transmit and/or receive a wired or wireless communication, and/or one or more other communications devices.

In some embodiments, the data store 724 stores a plurality of PSKs and the memory 720 comprises computer instruction code 722 which is executable by the processor 710 to perform selecting of an active PSK to be used for authentication within the IKE protocol from the multiple PSKs. The key ID discussed herein can be used to identify the active PSK to the second computing device 600.

Embodiments of the present invention enable a key management system to be integrated with a PSK-authenticated IKE by identifying a PSK that is in use for a user, computing device or connection. Embodiments of the present invention also enable multiple connections using the same PSK.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of integrating a key management system with a Pre-Shared Key (PSK)-authenticated Internet Key Exchange (IKE), the method comprising:
generating, via a first computing device, an IKE Identification Payload including an Identification Data field comprising:
a user identifier (ID) field uniquely identifying one or more of a user of the first computing device, the first computing device and a connection between the first computing device and another computing device;
a key ID field uniquely identifying a PSK; and
a separator between the user ID field and the key ID field; and
transmitting, from the first computing device to a second computing device as part of the IKE, the IKE Identification Payload.

2. The method of claim 1, wherein the key ID field in the Identification Data field of the IKE Identification Payload enables the second computing device to identify the PSK.

3. The method of claim 1, wherein the user ID field in the Identification Data field of the IKE Identification Payload enables the second computing device to identify one or more of the user, the first computing device and the connection.

4. The method of claim 1, wherein the user ID field comprises one or more of the following:
a device serial number of the first computing device;
a subscriber ID of the first computing device; and
a subscriber ID of the user.

5. The method of claim 4, wherein the user ID field has the format:
“<device serial number>-<subscriber ID>”.

6. The method of claim 1, wherein the key ID field comprises a key ID and one or more of the following:
a communications standard ID;
a manufacturer ID; and
an algorithm ID.

7. The method of claim 6, wherein the key ID field has the format:
“<communications standard ID>.<manufacturer ID>.<algorithm ID>-<key ID>”.

8. The method of claim 1, wherein the Identification Data field is formatted as one of the following:
a Request for Comments (RFC) 822 compliant address; and
a fully qualified domain name (FQDN).

9. The method of claim 1, wherein the Identification Data field has the format:
“<user ID field>@<key ID field>”.

10. A second computing device for integrating a key management system with a Pre-Shared Key (PSK)-authenticated Internet Key Exchange (IKE), the second computing device comprising:
a processor;
a communications device coupled to the processor;
a memory coupled to the processor, the memory comprising computer instruction code executable by the processor to perform the following:
receiving, from a first computing device via the communications device, an IKE Identification Payload including an Identification Data field comprising:
a user identifier (ID) field;
a key ID field; and
a separator between the user ID field and the key ID field;
identifying, using the user ID field, one or more of a user of the first computing device, the first computing device, and a connection between the first computing device and another computing device; and
identifying a unique PSK corresponding to the key ID field.

11. The second computing device of claim 10, wherein the user ID field comprises one or more of the following:
a device serial number of the first computing device;
a subscriber ID of the first computing device; and
a subscriber ID of the user.

12. The second computing device of claim 11, wherein the user ID field has the format:
“<device serial number>-<subscriber ID>”.

13. The second computing device of claim 10, wherein the key ID field comprises a key ID and one or more of the following:
a communications standard ID;
a manufacturer ID; and
an algorithm ID.

14. The second computing device of claim 13, wherein the key ID field has the format:
“<communications standard ID>.<manufacturer ID>.<algorithm ID>-<key ID>”.

15. The second computing device of claim 10, wherein the Identification Data field is formatted as one of the following:
a Request for Comments (RFC) 822 compliant address; and
a fully qualified domain name (FQDN).

16. The second computing device of claim 10, wherein the Identification Data field has the format:
“<user ID field>@<key ID field>”.

17. The second computing device of claim 10, wherein computer instruction code executable by the processor identifies the unique PSK using a list of key IDs mapped to corresponding unique PSKs.

18. The second computing device of claim 17, wherein the memory comprises computer instruction code executable by the processor to map one or more user IDs to an invalid PSK.

19. The second computing device of claim 18, wherein a user ID identifying the first computing device is mapped to an invalid PSK and the invalid PSK is used to fail authentication of the first computing device.

20. The second computing device of claim 17, wherein the memory comprises computer instruction code executable by the processor to map one or more user IDs to a valid PSK.

21. The second computing device of claim 20, wherein a user ID identifying the first computing device is mapped to a valid PSK and the valid PSK is used to successfully authenticate the first computing device.

22. The second computing device of claim 10, wherein the second computing device is an IKE server.
